(19) United States
(12) Patent Application Publication
(10) Pub. No.: US 2009/0252663 A1
(43) Pub. Date: Oct. 8, 2009

(54) Method and system for the removal of an elemental trace contaminant from a fluid stream

(76) Inventor: Todd Marshall Wetherill, Painted Post, NY (US)

Correspondence Address: CORNING INCORPORATED, SP-TI-3-1, CORNING, NY, 14831, US

(21) Appl. No.: 12/080,341

(22) Filed: Apr. 2, 2008

(51) Int. Cl. B01D 53/64; B01D 53/46

(52) U.S. Cl. 423/210; 422/169

(57) ABSTRACT

A method for the removal of an elemental trace contaminant from a fluid stream, which comprises:
passing a fluid stream comprising an elemental trace contaminant through a flow-through monolith comprising an oxidation catalyst to oxidize the elemental trace contaminant; and
contacting the fluid stream comprising the oxidized trace contaminant with a sorbent free of oxidation catalyst to sorb the oxidized trace contaminant.

### FIELD OF THE DISCLOSURE

This disclosure relates to a method and system for the removal of an elemental trace contaminant, such as elemental mercury, from a fluid stream.

### BACKGROUND

Hazardous contaminant emissions have become environmental issues of increasing concern because of the dangers posed to human health. For instance, coal-fired power plants and medical waste incineration are major sources of human activity related mercury emission into the atmosphere. Elemental mercury and its variants, such as methylmercury, are global pollutants.

It has been reported that human inhalation of elemental mercury has acute effects on kidneys and the central nervous system (CNS), such as mild transient proteinuria, acute renal failure, tremors, irritability, insomnia, memory loss, neuromuscular changes, headaches, slowed sensory-motor nerve function, and reduction in cognitive function. Acute inhalation of elemental mercury can affect gastrointestinal and respiratory systems, causing chest pains, dyspnea, cough, pulmonary function impairment, and interstitial pneumonitis. Studies also indicate that chronic exposure to elemental mercury can cause adverse effects on kidneys and the CNS, including erethism (increased excitability), irritability, excessive shyness, insomnia, severe salivation, gingivitis, tremors, and the development of proteinuria.

The main route of human exposure to methylmercury is the diet, such as by eating fish. Acute exposure to methylmercury can cause CNS effects such as blindness, deafness, and impaired level of consciousness. Chronic exposure to methylmercury results in symptoms such as paresthesia (a sensation of prickling on the skin), blurred vision, malaise, speech difficulties, and constriction of the visual field.

It is estimated that there are 48 tons of mercury emitted from coal-fired power plants in the United States annually. One DOE-Energy Information Administration annual energy outlook projected that coal consumption for electricity generation will increase from 976 million tons in 2002 to 1,477 million tons in 2025 as the utilization of coal-fired generation capacity increases. However, mercury emission control regulations have not been rigorously enforced for coal-fired power plants. A major reason is a lack of effective control technologies available at a reasonable cost, especially for elemental mercury control.

Activated carbon honeycombs disclosed in US 2007/0261557 may be utilized to achieve high removal levels of trace contaminants such as toxic metals. These activated carbon honeycombs may also include co-catalysts, such as certain metals, metal compounds, CaO, CaSO₄, CaCO₃, Al₂O₃, SiO₂, KI, Fe₂O₃, CuO, zeolite, kaolinite, lime, limestone, fly ash, sulfur, thiol, pyrite, bauxite, zirconia, halogens and halogen-containing compounds, and sulfur and sulfur-containing compounds. These activated carbon honeycombs can thus be used for the oxidation of an elemental toxic metal, for example, as well as sorption of the oxidized metal, within the same material.

A need still exists, however, for system level designs for the removal of elemental trace contaminants such as mercury from fluid streams. In this regard, the presence of an oxidation catalyst on a sorbent could potentially limit the capacity of the sorbent by blocking pores or compromising the diffusion path of the trace contaminant into the sorbent matrix.

The inventor has discovered a new system level and multi-stage approach to the oxidation of elemental trace contaminants and their capture in a sorbent. The method and system involve oxidation of the elemental trace contaminant by way of an oxidation catalyst on a flow-through monolith, and sorption of the oxidized trace contaminant on a sorbent free of oxidation catalyst. The absence of an oxidation catalyst on the sorbent allows the sorbent matrix to remain clear for sorption of the trace contaminant. The two stages may be independent in materials, design, and manufacturing. They may be individually optimized for performance, cost, and operating systems, and are brought together at the system level.

### BRIEF DESCRIPTION OF THE DRAWINGS

The invention can be understood from the following detailed description either alone or together with the accompanying drawings. The drawings are included to provide a further understanding of the invention, and are incorporated in and constitute a part of this specification. The drawings illustrate one or more embodiments of the invention and together with the description serve to explain the principles and operation of the invention.

FIG. 1 illustrates an example system according to one embodiment of the invention, with an oxidation stage and sorption stage in contact with one another.

FIG. 2 illustrates an example system according to one embodiment of the invention, with an oxidation stage and sorption stage separated by a predetermined distance.

FIG. 3 illustrates an example system according to one embodiment of the invention, with an oxidation stage and sorption stage included in the same honeycomb monolith.

FIG. 4 illustrates an example system according to one embodiment of the invention, with an oxidation stage and sorption stage separated by a predetermined distance, comprising a stacked configuration of honeycomb monoliths.

### DESCRIPTION OF EMBODIMENTS OF THE INVENTION

One embodiment of the invention is a method for the removal of an elemental trace contaminant from a fluid stream, which comprises:

passing a fluid stream comprising an elemental trace contaminant through a flow-through monolith comprising an oxidation catalyst to oxidize the elemental trace contaminant; and

contacting the fluid stream comprising the oxidized trace contaminant with a sorbent free of oxidation catalyst to sorb the oxidized trace contaminant.

Another embodiment of the invention is a system for the removal of an elemental trace contaminant from a fluid stream, which comprises:

a flow-through monolith comprising an oxidation catalyst for oxidizing an elemental trace contaminant in a fluid stream that can be passed through the flow-through monolith; and

a sorbent free of oxidation catalyst positioned downstream of the oxidation catalyst to sorb a trace contaminant oxidized by the oxidation catalyst.

The flow-through monolith comprising the oxidation catalyst will frequently be referred to herein as “the oxidation stage,” although it is to be understood that elemental or oxidized trace contaminant may or may not be sorbed on such a flow-through monolith. The sorbent free of oxidation catalyst will frequently be referred to herein as “the sorption stage.” The combination of the two will frequently be referred to as a “multi-stage” approach.

The multi-stage approach made possible with the embodiments discussed above can have one or more advantages compared to oxidation and sorption taking place concurrently on one material. For instance, absence of an oxidation catalyst in the sorption stage may improve its sorption capacity. The oxidation stage and sorption stage may also be individually customized to maximize performance for a given power plant with a typical elemental/oxidized mercury ratio in flue gas. Individually optimized flow-through monolith and sorbent lengths or volumes could allow for smaller material requirements over all, and thus enable lower pressure drop and lower cost compared to a “one size fits all” approach in a single product geometry.

Plant shutdown outages may require change of either the oxidation stage or sorption stage, but potentially not both. Permitting the replacement of one without replacement of the other could lower operating costs by lower material requirements, and smaller material handling requirements. A multi-stage approach may also offer regeneration or reuse benefits. In this regard, the individual stages may be regenerated more effectively than a single substrate solution.

A multi-stage approach could also offer flexibility in installation. Due to existing structures, a plant may prefer to install the oxidation stage at one upstream location, and the sorption stage at a different, but nearby downstream location, around a bend, up a duct etc. A multi-stage approach might also enable strategic placement of the stages within temperature zones of a flue gas path that would make them individually more effective.

The invention may be used in the context of the sorption of any elemental trace contaminant from a fluid stream. The fluid stream may be in the form of a gas or a liquid. The gas or liquid may also contain another phase, such as a solid particulate in either a gas or liquid stream, or droplets of liquid in a gas stream. Example gas streams include combustion flue gases (such as from bituminous and sub-bituminous coal types or lignite coal) and syngas streams produced in a coal gasification process.

Elemental trace contaminants include, for instance, elemental contaminants at 3 wt % or less within the fluid stream, for example at 2 wt % or less, or 1 wt % or less. Elemental trace contaminants may also include, for instance, elemental contaminants at 10,000 μg/m³ or less within the fluid stream.

Example trace contaminants include metal elements, including toxic metal elements. Example toxic metals include cadmium, mercury, chromium, lead, barium, and beryllium. In one embodiment, the toxic metal is mercury. Other exemplary metallic elemental trace contaminants include nickel, cobalt, vanadium, zinc, copper, manganese, antimony, silver, and thallium. Additional elemental trace contaminants include arsenic and selenium.

The elemental trace contaminant may be in any phase that can be passed through the flow-through monolith comprising the oxidation catalyst. Thus, the trace contaminant may be present, for example, as a liquid in a gas fluid steam, or as a liquid in a liquid fluid stream. The trace contaminant could alternatively be present as a gas phase contaminant in a gas or liquid fluid stream. In one embodiment, the trace contaminant is mercury vapor in a combustion flue gas or syngas stream.

Embodiments of the invention comprise passing the fluid stream comprising the elemental trace contaminant through a flow-through monolith comprising an oxidation catalyst to oxide the trace contaminant. In this context, oxidation of the elemental trace contaminant converts the elemental form of the contaminant to an oxidized state. For instance, in one embodiment, elemental mercury (Hg^{o}) is converted to an oxidized state (Hg⁺ or Hg²⁺). Example forms of oxidized mercury include HgO and halogenated mercury, for example Hg₂Cl₂ and HgCl₂. The oxidized state of a metal, for example, therefore includes any organic or inorganic compound or composition comprising the metal.

The flow-through monolith may comprise the oxidation catalyst in any suitable portion of the monolith body. In one embodiment, the flow-through monolith comprises the oxidation catalyst throughout the entire monolith, or at least throughout the surfaces of the monolith that would be exposed to the fluid stream. In other embodiments, the flow-through monolith comprises the oxidation catalyst in one or more distinct portions of the monolith. The oxidation catalyst may be provided on the flow-through monolith by being present in a batch mixture used to form the flow-through monolith, or may be coated onto a monolith that has already been formed, for example using a wash-coating technique.

The flow-through monolith comprising the oxidation catalyst may be in any suitable form, such as a honeycomb monolith. The flow-through monolith, such as a honeycomb monolith, may comprise, for instance, a glass, glass-ceramic, ceramic, or metal honeycomb comprising a coating of the oxidation catalyst.

Example oxidation catalysts include metal elements, metal compounds, halogens, and halogenated compounds. For instance, the oxidation catalyst may comprise a transition metal or transition metal compound. Exemplary oxidation catalysts include Au, Pt, Pd, Cu, Ni, Ru, Rh, Ir, Co, Fe, Mn, and inorganic or organic compounds comprising these.

In some embodiments, the portion of the flow-through monolith comprising the oxidation catalyst sorbs no or essentially no oxidized trace contaminant. In other embodiments, the flow-through monolith does sorb oxidized trace contaminant. Thus, reference to the flow-through monolith comprising the oxidation catalyst as the “oxidation stage” does not preclude sorption of oxidized trace contaminant on the flow-through monolith comprising the oxidation catalyst.

Embodiments of the invention further comprise contacting the fluid stream comprising the oxidized trace contaminant with a sorbent free of oxidation catalyst to sorb the oxidized trace contaminant. The sorbent free of oxidation catalyst may also sorb elemental trace contaminant that may remain in the fluid stream. The sorbent free of oxidation catalyst may also sorb an oxidized trace contaminant that may have been present in the fluid stream even before passage through the flow-through monolith comprising the oxidation catalyst.

The terms “sorb,” “sorption,” and “sorbed” used in the context of the invention refer to the adsorption, absorption, or other entrapment of the trace contaminant, either physically, chemically, or both physically and chemically.

The sorbent free of oxidation catalyst may be made of any material suitable for practice of the invention. For instance, the sorbent may comprise activated carbon and may be in the form of a continuous activated carbon body, with or without additional materials included in the activated carbon matrix. Alternatively, the sorbent free of oxidation catalyst may be a glass, glass-ceramic, ceramic, or metal body, coated with activated carbon. The activated carbon material in either case may further comprise sulfur and/or a catalyst that catalyzes the sorption of the trace contaminant from the fluid stream. The sulfur and/or catalyst may be present in the batch mixture used to form the activated carbon material, or may be coated onto the material has already been formed, for example using a wash-coating technique. In this regard, the term “sulfur” includes both elemental sulfur and sulfur in any oxidation state, including chemical compounds and compositions that comprise sulfur.

The sorbent free of oxidation catalyst may also be in any form suitable for practice of the invention. For instance, the sorbent free of oxidation catalyst may be a packed bed, particulates injected into the fluid stream, or a flow-through monolith distinct from the flow-through monolith comprising the oxidation catalyst. Exemplary flow-through monoliths include, for example, any monolithic structure comprising channels or porous networks permitting the flow of a fluid stream through the monolith.

As discussed above, flow-through monoliths may be utilized in the oxidation stage, the sorption stage, or both. In instances where both stages utilize a flow-through monolith, the monoliths can be configured to be non-identical with respect to any one or more physical and/or chemical properties. For example, the monoliths can comprise different monolithic structures, different compositions and, in the case of honeycombs for example, different cell densities, porous channel walls of differing thickness, or cell channels having differing sizes or cross-sectional geometries. Exemplary cell geometries for honeycombs can include circular, square, triangular, rectangular, hexagonal, sinusoidal, or any combination thereof. Honeycombs may also be positioned such that the cells of the honeycombs are offset from one another. Such a configuration may promote a splitting of fluid streams from the cells of one honeycomb into two or more cells of another downstream honeycomb.

FIG. 1 illustrates an example system 100 according to one embodiment of the invention. The flow-through monolith free of oxidation catalyst 106 is in this instance distinct from the flow-through monolith comprising the oxidation catalyst 104. A fluid stream may be passed from the inlet end of the system 102 through the outlet end of the system 108 to oxidize an elemental trace contaminant in the fluid stream and sorb the oxidized trace contaminant.

In FIG. 1, both flow-through monoliths are in the form of a honeycomb comprising an inlet end, an outlet end, and a multiplicity of cells extending from the inlet end to the outlet end, the cells being defined by intersecting porous cell walls. The honeycombs in each stage could optionally comprise one or more selectively plugged honeycomb cell ends to provide a wall flow-through structure that allows for more intimate contact between the fluid stream and cell walls.

In some embodiments, such as shown in FIG. 1, the oxidation stage and the sorption stage both comprise a honeycomb body. In this instance, the honeycomb in the oxidation stage may be identical to the honeycomb in the sorption stage, or may be non-identical with respect to at least one of: honeycomb length, cell size, and cell geometry. In other embodiments, only the oxidation stage or sorption stage comprises a honeycomb sorbent.

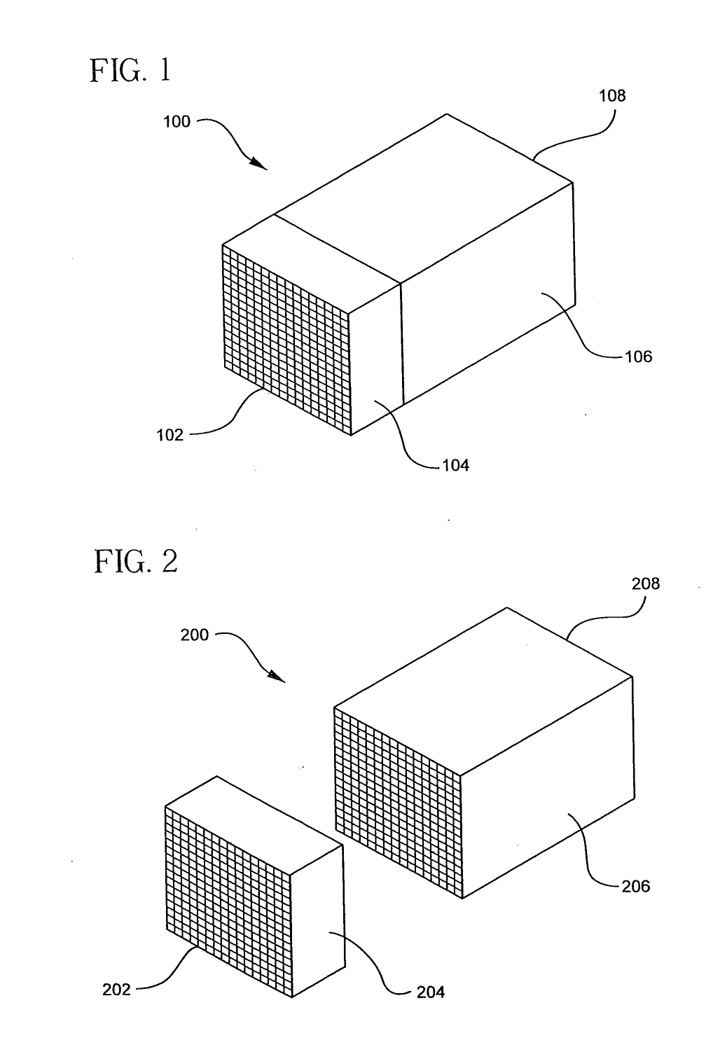

FIG. 2 illustrates another example system 200 according to one embodiment of the invention. In this instance, the flow-through monolith sorbent free of oxidation catalyst 206 is separated by a predetermined distance from the flow-through monolith comprising the oxidation catalyst 204. A fluid stream may be passed from the inlet end of the system 202 through the outlet end of the system 208 to oxidize an elemental trace contaminant in the fluid stream and sorb the oxidized trace contaminant.

A predetermined distance between the stages may be utilized, for example, to provide greater mixing of the fluid stream or to provide space for placement of mercury concentration detectors or fly ash removal systems. The space between the stages can be of any desirable length, such as from 6 inches to several feet or more.

Any space between the stages may optionally include other materials, such as a packed layer, that may provide, for example, added removal of trace contaminant from the fluid stream or that may chemically interact with the trace contaminant in the fluid stream. Suitable materials for such a packed layer include, for instance, activated carbon pellets, fly ash, cordierite, iron oxide, or aluminum oxide.

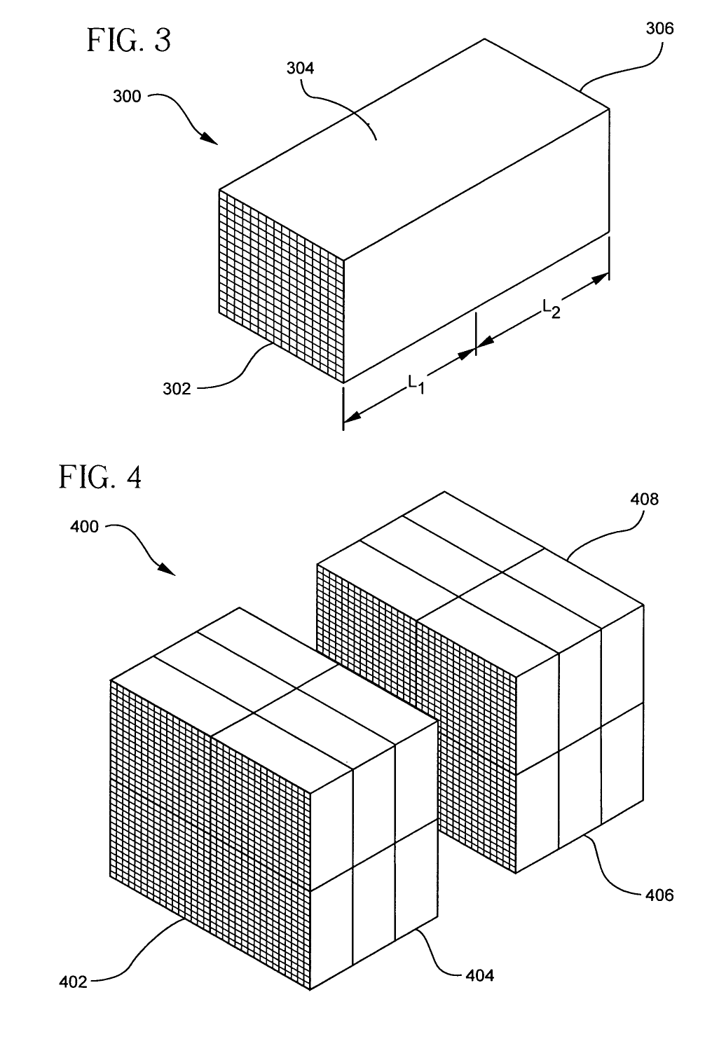

FIG. 3 illustrates another example system 300 according to one embodiment of the invention. In this instance, the oxidation stage along length L₁ of honeycomb 304 and the sorption stage along length L₂ of honeycomb 304 are included in the same honeycomb monolith. A fluid stream may be passed from the inlet end of the system 302 through the outlet end of the system 306 to oxidize an elemental trace contaminant in the fluid stream and sorb the oxidized trace contaminant.

Lastly, FIG. 4 illustrates an example system 400 according to a further embodiment of the invention. In this instance, oxidation stage 404 and sorption stage 406 are both in a stacked configuration of honeycomb monoliths and are separated by a predetermined distance. A fluid stream may be passed from the inlet end of the system 402 through the outlet end of the system 408 to oxidize an elemental trace contaminant in the fluid stream and sorb the oxidized trace contaminant.

The oxidation stage and sorption stage of the system may be positioned in any environment appropriate for the practice of the invention. For instance, one or both stages may be positioned within a duct or any other enclosure carrying the fluid stream such as a combustion flue gas or a syngas. One or more other components, such as a particulate collector, may be positioned within the flow of the fluid stream either upstream or downstream of either stage. For example, an electrostatic precipitator may be placed upstream of the system.

After a period of use, the flow-through monolith in the oxidation stage or the sorbent free of oxidation catalyst may become spent such that they no longer can provide a desired level of oxidation or sorption efficiency for the trace contaminant, respectively. To this end, one or more trace contaminant detectors or sensors may be positioned anywhere within the system or near or at the outlet end of the system to detect levels of the trace contaminant, either in elemental form or in an oxidized state. For example, a detector may be placed upstream of the oxidation stage, downstream of the oxidation stage but upstream of the sorption stage, and/or downstream of the sorption stage. The detectors or sensors can provide feedback indicating a concentration of trace contaminant (in elemental state and/or in any oxidation state) in the fluid stream at any given point within the system or near or at the outlet end of the system. In an exemplary embodiment, a suitable mercury sensor can be a continuous detection mercury analyzer manufactured by PS Analytical (Model PSA 10.680) or by Nippon Instruments (Model DM-6).

Accordingly, when the concentration of an elemental trace contaminant in the fluid stream downstream of the oxidation stage exceeds a predetermined level, being indicative of an oxidation efficiency at or below certain standards, the flow-through monolith comprising the oxidation catalyst may be replaced. Similarly, when the concentration of an oxidized trace contaminant at the outlet of the system exceeds a predetermined level, being indicative of a sorption efficiency at or below certain standards, the sorbent free of oxidation catalyst may be replaced.

It should be understood that while the invention has been described in detail with respect to certain illustrative embodiments thereof, it should not be considered limited to such, as numerous modifications are possible without departing from the broad spirit and scope of the invention as defined in the appended claims.

We claim:

1. A method for the removal of an elemental trace contaminant from a fluid stream, which comprises:
passing a fluid stream comprising an elemental trace contaminant through a flow-through monolith comprising an oxidation catalyst to oxidize the elemental trace contaminant; and
contacting the fluid stream comprising the oxidized trace contaminant with a sorbent free of oxidation catalyst to sorb the oxidized trace contaminant.

2. The method of claim 1, wherein the elemental trace contaminant is selected from cadmium, mercury, chromium, lead, barium, beryllium, arsenic and selenium.

3. The method of claim 1, wherein the elemental trace contaminant is mercury.

4. The method of claim 1, wherein the fluid stream is selected from a coal combustion flue gas and a syngas stream.

5. The method of claim 1, wherein the oxidation catalyst comprises a metal element, metal compound, a halogen, or a halogenated compound.

6. The method of claim 1, wherein the flow-through monolith comprising the oxidation catalyst is a honeycomb monolith.

7. The method of claim 1, wherein the flow-through monolith comprising the oxidation catalyst comprises a glass, glass-ceramic, ceramic, or metal honeycomb comprising a coating of the oxidation catalyst.

8. The method of claim 1, wherein the portion of the flow-through monolith comprising the oxidation catalyst sorbs essentially no oxidized trace contaminant.

9. The method of claim 1, wherein the sorbent free of oxidation catalyst is a continuous activated carbon body.

10. The method of claim 1, wherein the sorbent free of oxidation catalyst is a packed bed.

11. The method of claim 1, wherein the sorbent free of oxidation catalyst comprises sorbent particulates injected into the fluid stream.

12. The method of claim 1, wherein the sorbent free of oxidation catalyst is a flow-through monolith distinct from the flow-through monolith comprising the oxidation catalyst.

13. The method of claim 12, wherein the flow-through monolith sorbent free of oxidation catalyst is separated by a predetermined distance from the flow-through monolith comprising the oxidation catalyst.

14. The method of claim 12, wherein the flow-through monolith sorbent free of oxidation catalyst is connected to or in contact with the flow-through monolith comprising the oxidation catalyst.

15. The method of claim 12, wherein the flow-through monolith sorbent free of oxidation catalyst is a honeycomb monolith.

16. The method of claim 12, wherein the flow-through monolith sorbent free of oxidation catalyst is a honeycomb monolith and is non-identical to the flow-through monolith comprising the oxidation catalyst, which is also a honeycomb monolith, with respect to at least one of: honeycomb length, cell size, and cell geometry.

17. The method of claim 1, wherein the sorbent free of oxidation catalyst is within a downstream portion of the same flow-through monolith comprising the oxidation catalyst.

18. A system for the removal of an elemental trace contaminant from a fluid stream, which comprises:
a flow-through monolith comprising an oxidation catalyst for oxidizing an elemental trace contaminant in a fluid stream that can be passed through the flow-through monolith; and
a sorbent free of oxidation catalyst positioned downstream of the oxidation catalyst to sorb a trace contaminant oxidized by the oxidation catalyst.

19. A system of claim 18, wherein the sorbent free of oxidation catalyst is a flow-through monolith distinct from the flow-through monolith comprising the oxidation catalyst.

20. A system of claim 18, wherein the sorbent free of oxidation catalyst is within a downstream portion of the same flow-through monolith comprising the oxidation catalyst.

21. A system of claim 18, wherein the portion of the flow-through monolith comprising the oxidation catalyst has essentially no capacity to sorb an oxidized trace contaminant.
